(19) United States
(12) Patent Application Publication
(10) Pub. No.: US 2014/0124705 A1
(43) Pub. Date: May 8, 2014

(54) OXY-FUEL COMBUSTION

(71) Applicant: Haldor Topsoe A/S, Kgs. Lyngby (DK)

(72) Inventors: Niels Ulrik Andersen, Gentofte (DK); Martin Østberg, Roskilde (DK)

(73) Assignee: Haldor Topsoe A/S, Kgs. Lyngby (DK)

(21) Appl. No.: 14/072,533

(22) Filed: Nov. 5, 2013

(30) Foreign Application Priority Data
Nov. 7, 2012 (DK) PA 201270682

(51) Int. Cl. C01B 3/36

(52) U.S. Cl. CPC C01B 3/36
USPC 252/373

(57) ABSTRACT

A process for the production of synthesis gas with reduced carbon dioxide foot-print via recycling of carbon dioxide produced in the process to the burners of the steam reformer.

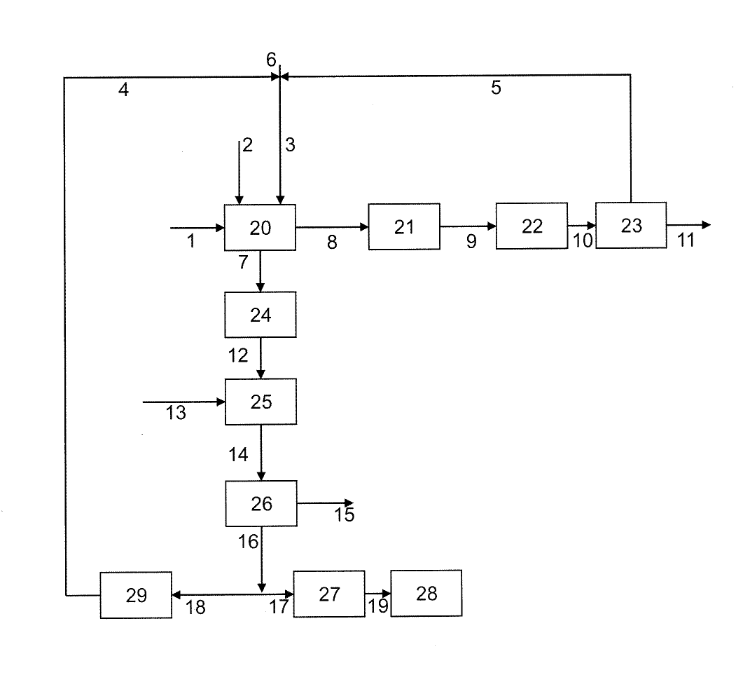

### BACKGROUND OF THE INVENTION

The present invention relates to a method for reducing carbon dioxide emissions to the atmosphere during reforming of hydrocarbons. In particular the invention relates to a method for operating burners in reforming units with reduced carbon dioxide emissions to the atmosphere, more particularly the burners of fired reformers such as tubular reformers and convective reformers.

Oxy-fuel combustion is a known method for conducting the combustion of fuels with oxygen or enriched air. This method generates a flue gas with lower content of nitrogen and thereby higher concentration of carbon dioxide. This is an advantage where there is a desire to capture the produced carbon dioxide from the combustion process, for instance by sequestration. Thus, oxy-fuel combustion allows easy carbon dioxide recovery as the flue gas will mainly contain carbon dioxide and water, with subsequent sequestration or other use of the carbon dioxide, thereby reducing the carbon dioxide foot-print of the plant.

However, burning fuels with oxygen or enriched air (typically about 40 mol % oxygen) results in much higher flame temperatures, which may not be acceptable for the burners of the reformer where the combustion process takes place. Such a reformer may be a conventional tubular reformer (side or top-fired tubular reformer), a convective reformer where flue gas from the burner is used as heat exchanging medium for the endothermic reforming reactions as for instance described in U.S. Pat. No. 5,925,328, or a bayonet reformer that combines convection and radiant heat transfer in a single steam reformer.

Hence, to make oxy-fuel combustion applicable to such reformers, it is necessary to moderate flame temperatures, otherwise there is high risk of material damage as the burners and accessory equipment used for reforming are normally not capable of handling undiluted oxy-fuel combustion, unless high expensive alloy materials are used to withstand the higher flame temperatures.

A method to reduce the flame temperatures without loosing the associated effect of a high concentration of carbon dioxide in the flue gas is to add concentrated carbon dioxide to the fuel-oxidant mixture. Apart from the effect of the dilution resulting in lower flame temperatures, it can also enhance gas radiation in the furnace since carbon dioxide unlike nitrogen is an emitting molecule. This is in particular advantageous in reformers, since the radiation from a flame to cooler surfaces like reformer tubes containing the steam reforming catalyst and the reactant mixture is enhanced.

It is known from for instance U.S. Pat. No. 8,007,681 and US Patent Application Publ. No. 2012/0131925 to use carbon dioxide as diluent or inert during fuel combustion according to the oxy-fuel principle in for instance steam methane reformers. Excess water is normally produced in the flue gas and left in the recycle.

### SUMMARY OF THE INVENTION

The present invention provides an alternative method for oxy-fuel combustion in reforming according to the following features in correspondence with the appended claims:
1. Method for operating a burner in a steam reformer comprising: (a) mixing a fuel and an oxidant gas and burning the resulting mixture; (b) recovering from the reformer a flue gas stream containing carbon dioxide and water, and splitting the stream into a flue gas recycle stream and a separate stream for carbon dioxide recovery; (c) recovering from the reformer a separate stream of reformed gas containing carbon monoxide, carbon dioxide, hydrogen and water; (d) recovering a carbon dioxide stream from the reformed gas by passing the reformed gas through a carbon dioxide removal section; (e1) combining at least a portion of the flue gas recycle stream with an oxygen or enriched oxygen stream to form the oxidant gas of step a), or (e2) combining at least a portion of the carbon dioxide stream from the reformed gas with an oxygen or enriched oxygen stream to form the oxidant gas of step a), or (e3) combining at least a portion of the flue gas recycle stream with at least a portion of the carbon dioxide stream from the reformed gas, and combining with the oxygen or enriched oxygen stream to form the oxidant stream of step a);
wherein step (b) further comprises removing oxygen from the flue gas before splitting into said flue gas recycle stream and said separate stream for carbon dioxide recovery.
2. Method according to feature 1 further comprising subjecting the reformed gas to a water gas shift stage before passing the gas through the carbon dioxide removal section.
3. Method according to features 1 or 2 in which step (b) further comprises removing water from the flue gas stream before splitting into said flue gas recycle stream and said separate stream for carbon dioxide recovery.
4. Method according to features 1 or 2 in which the step of removing oxygen from the flue gas is conducted via a catalytic oxidizer.
5. Method according to feature 4 in which removing oxygen is conducted by catalytic oxidation in the presence of a fuel with a catalyst comprising one or more noble metals, copper, manganese, vanadium, or combinations thereof.
6. Method according to feature 5 in which the fuel is carbon monoxide.
7. Method according to any preceding features in which the steam reformer is selected from: tubular reformer, convective reformer, bayonet reformer that combines convection and radiant heat transfer in a single steam reformer.

According to the invention, the carbon dioxide for the burner(s) may be derived from the separate process lines withdrawn from the steam reformer: the flue gas line or the reforming process line, or preferably both.

To ensure that the carbon dioxide is oxygen free, the remaining oxygen in the flue gas is preferably converted over a catalytic oxidation catalyst by addition of a fuel, such as synthesis gas, hydrogen or carbon monoxide. Preferably the fuel is synthesis gas, which is a gas containing carbon monoxide, carbon dioxide and hydrogen.

More preferably the fuel for the catalytic oxidation is carbon monoxide. The product of this process is CO₂ where part of it comes from the oxidation of CO, and as a result high purity of CO₂ in the recycled flue gas is obtained. The concentration of oxygen in the flue gas from the reformer is normally 1-10 mol % before catalytic oxidation and 0.5-1 mol % after catalytic oxidation.

The catalytic oxidation is conducted via a catalyst comprising: one or more noble metals (such as palladium or platinum), copper, manganese, vanadium, or combinations thereof, preferably supported on a suitable carrier, such as alumina carrier.

It would be understood that the removal of oxygen in the flue gas before splitting the gas is highly counter-intuitive, as the resulting gas (a part of which is recycled) is deprived from oxygen which is otherwise necessary for the burner(s) of the steam reformer when later returned as the flue gas recycle stream.

In a particular embodiment, the further step (in step (b)) of removing water from the flue gas stream before splitting into said flue gas recycle stream and said separate stream for carbon dioxide recovery, is conducted after said step of removing oxygen from the flue gas.

In the reforming process line the carbon dioxide removal section is preferably an amine wash.

We have also found that using water gas shift before carbon dioxide removal in the reforming process line is advantageous particularly where the synthesis gas is for downstream production of hydrogen. The water gas shift enables higher production of carbon dioxide in the reformed gas.

### BRIEF DESCRIPTION OF THE DRAWING

The invention is further illustrated by reference to the attached figure which shows a schematic of a specific embodiment of the invention in which carbon dioxide from flue gas and reformed gas are used in the burners of the steam reformer in a hydrogen plant.

### DETAILED DESCRIPTION OF THE PREFERRED EMBODIMENT

A reformer hydrocarbon feed such as natural gas or pre-reformed natural gas 1 is added to steam reformer 20, while fuel 2 and oxidant gas 3 are added to the burner(s) of the steam reformer. The oxidant gas 3 results from combining carbon dioxide rich streams in the form of flue gas recycle stream 4 and carbon dioxide stream 5 with oxygen stream 6. From steam reformer 20 two process lines emerge: a flue gas stream 7 containing carbon dioxide and water, and a separate stream of reformed gas 8 containing carbon monoxide, carbon dioxide, hydrogen and water. The reformed gas 8 is cooled in cooling train 21 comprising one or more waste heat boilers, thus forming cooled process gas 9 which is then passed through water gas shift unit(s) 22 to form a process gas 10 having a higher content of hydrogen and carbon dioxide. The carbon dioxide is withdrawn as carbon dioxide rich stream 5 in CO₂ removal section 23 under the production of synthesis gas 11 for downstream production of hydrogen. The flue gas stream 7 containing up to 10 mol % oxygen passes through a first waste heat section where the flue gas is cooled. The cooled flue gas 12 is then passed through catalytic oxidizer for oxygen removal and second waste heat section 25 under the addition of a suitable fuel 13 such as carbon monoxide. The flue gas stream 14, now containing 1 mol % oxygen or below is then cooled in unit 26, while water 15 is condensed and removed. The now carbon dioxide rich flue gas stream 16 is split into two carbon dioxide rich streams 17 and 18. Stream 17 is transported by compressor 27 as carbon dioxide rich stream 19 to sequestration or other utilization unit(s) 28. Stream 18 is the flue gas recycle stream which is returned to the burners of steam reformer 20 as stream 4 by blower 29.

What is claimed is:

1. Method for operating a burner in a steam reformer comprising: (a) mixing a fuel and an oxidant gas and burning the resulting mixture; (b) recovering from the reformer a flue gas stream containing carbon dioxide and water, and splitting the stream into a flue gas recycle stream and a separate stream for carbon dioxide recovery; (c) recovering from the reformer a separate stream of reformed gas containing carbon monoxide, carbon dioxide, hydrogen and water; (d) recovering a carbon dioxide stream from the reformed gas by passing the reformed gas through a carbon dioxide removal section; (e1) combining at least a portion of the flue gas recycle stream with an oxygen or enriched oxygen stream to form the oxidant gas of step a), or (e2) combining at least a portion of the carbon dioxide stream from the reformed gas with an oxygen or enriched oxygen stream to form the oxidant gas of step a), or (e3) combining at least a portion of the flue gas recycle stream with at least a portion of the carbon dioxide stream from the reformed gas, and combining with the oxygen or enriched oxygen stream to form the oxidant stream of step a);
wherein step (b) further comprises removing oxygen from the flue gas before splitting into said flue gas recycle stream and said separate stream for carbon dioxide recovery.

2. Method according to claim 1 further comprising subjecting the reformed gas to a water gas shift stage before passing the gas through the carbon dioxide removal section.

3. Method according to claim 1 in which step (b) further comprises removing water from the flue gas stream before splitting into said flue gas recycle stream and said separate stream for carbon dioxide recovery.

4. Method according to claim 1 in which the step of removing oxygen from the flue gas is conducted via a catalytic oxidizer.

5. Method according to claim 4 in which removing oxygen is conducted by catalytic oxidation in the presence of a fuel with a catalyst comprising one or more noble metals, copper, manganese, vanadium, or combinations thereof.

6. Method according to claim 5 in which the fuel is carbon monoxide.

7. Method according to claim 1 in which the steam reformer is selected from: tubular reformer, convective reformer, bayonet reformer that combines convection and radiant heat transfer in a single steam reformer.
